(19) United States
(12) Patent Application Publication
(10) Pub. No.: US 2021/0030517 A1
(43) Pub. Date: Feb. 4, 2021

(54) MAXIMIZED AREA OSSEOINTEGRATED CUSTOM IMPLANTS

(71) Applicant: CAO Group, Inc., West Jordan, UT (US)

(72) Inventor: Steven D Jensen, South Jordan, UT (US)

(21) Appl. No.: 16/917,567

(22) Filed: Jun. 30, 2020

Related U.S. Application Data
(60) Provisional application No. 62/880,399, filed on Jul. 30, 2019.

(51) Int. Cl. A61C 13/00; A61C 8/00; A61C 13/09; A61C 13/083; A61C 13/34

(52) U.S. Cl. CPC A61C 13/0004; A61C 8/0012; A61C 8/0001; A61C 13/083; A61C 13/34; A61C 13/09

(57) ABSTRACT

Customized dental implants feature enhanced osseointegrable qualities by manufacturing the implant post with osseointegrable material and preparing a larger post body, including a portion to cover a prepared bone surface, to integrate with a jawbone. Resultant implants are more durable and provide a better fir into the oral cavity. Various implant shapes and designs are disclosed.

### CROSS-REFERENCES TO RELATED APPLICATIONS

This Application claims priority as a non-provisional perfection of prior filed U.S. Application No. 62/880,399, filed Jul. 30, 2019, and incorporates the same herein by reference in its entirety.

### FIELD OF THE INVENTION

The present invention relates to the field of dentistry and more particularly relates to a customizable dental implant which uses a greater osseointegrable area of a patient's jaw.

### BACKGROUND OF THE INVENTION

One modern dental restorative technique is the use of a dental implant to replace a damaged or diseased tooth. Implants offer convenience over the traditional use of false teeth as they are permanently attached to the jawbone of the patient and do not need to be removed. The patient merely brushes and cares for his or her teeth as usual to also care for the implant. Contemporary dental implants consist of a titanium post that is inserted into bone and through a healing process eventually becomes osseointegrated. Osseointegration is the firm anchoring of a surgical implant by the growth of bone around it, without soft or fibrous tissue formation at the interface. In short, the bone grows directly over and around the implant, forming a secure hold. Once healed, a prosthetic that resembles a tooth is then attached to the titanium post abutment to complete the restoration. They are free-floating and are only attached via the small circumference of the titanium post abutment. There is gap between the prosthetic and the healed soft tissue beneath it and this gap becomes an area that becomes packed with food, bacteria, and debris, and must be constantly cleaned or may develop into periodontal infections over the course of time. The elimination of this gap would reduce such infections.

The present invention represents a departure from the prior art in that the dental implants of the present invention allows for implants that are not limited to an osseointegration area defined by an inserted structure such as a titanium post or fin, which only represents a portion of the total available osseointegrable area. The present invention produces custom implants that are designed to fit the entire exposed bone surface, including any area between the prosthetic restoration and any adjacent bone. The purpose is to provide for a fully integrated implant with increased strength and durability because it is integrated over a maximized surface area.

### SUMMARY OF THE INVENTION

In view of the foregoing disadvantages inherent in the known types of dental implants, an improved implant may provide an improved implant that meets the following objectives: it is relatively simple and safe to implant, that it sufficiently osseointegrate with patient tissues, that it minimize gaps that may lead to infection, and that it be reasonably cost effective. As such, the new and improved dental implants may comprise a support installed in a patient's jaw that holds an implant formed of an osseointegrable material to accomplish these objectives.

The present invention is designed to utilize osseointegrable materials, such as bone, teeth, artificial bone, artificial teeth, coral, seashells, calcium phosphates, calcium carbonate, calcium phosphate tribasic, calcium phosphate dibasic, calcium phosphate monobasic, porcelains, ceramics, cements, metals, and any other materials that osseointegrate. An embodiment of the present invention utilizes osseointegrable materials capable of forming a hard and durable aggregated mass. An embodiment of the present invention prefers osseointegrable materials in the form of a block; wherein the block is capable of being installed onto a milling machine and machined into a desired shape. A preferred embodiment of the present invention utilizes osseointegrable materials in the form of a block, which is then installed on a milling machine and machined into a form of a customized implant prosthetic.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view demonstrating surgical preparation of an area to receive an implant.

FIG. 2 is a close-up view of the prepared area of FIG. 1.

FIG. 3 is a perspective view of an impression taken of an area prepared according to at least one embodiment of the invention.

FIG. 4 is a perspective view of an osseointegrable block of material before milling.

FIG. 5 is a perspective view of a restorative crown and an implant post milled from the osseointegrable block of FIG. 4.

FIG. 6 is perspective view depicting the insertion of the post of FIG. 5 into the area of FIG. 2.

FIG. 7 is a sectional view of the prepared area of FIG. 2, after post insertion.

FIG. 8 is a sectional view of the prepared area of FIG. 7, after osseointegration of the post.

FIG. 9 is a sectional view of the prepared area of FIG. 8, after placement of the restorative crown.

FIGS. 10A-10G are perspective views of alternate implant post designs.

FIG. 11 is a perspective view of an alternate embodiment of an implant post and restorative crown.

FIG. 12 is a close-up view of the implant post of FIG. 11, taken in circle XII.

FIGS. 13A-13C are further close-up views of alternate implant post deigns.

### DETAILED DESCRIPTION OF THE PREFERRED EMBODIMENT

With reference now to the drawings, a preferred embodiment of the osseointegrable custom implants is herein described. It should be noted that the articles “a”, “an”, and “the”, as used in this specification, include plural referents unless the content clearly dictates otherwise.

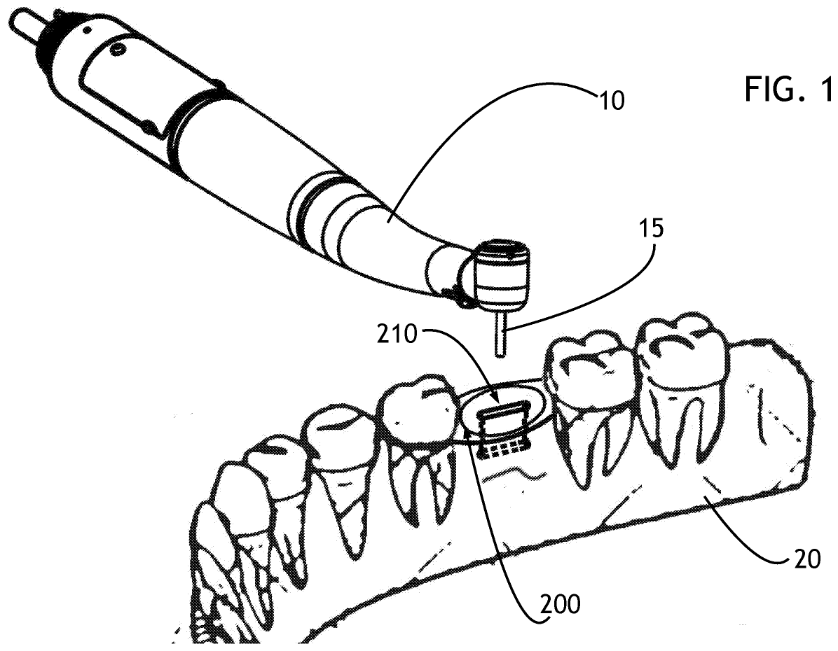

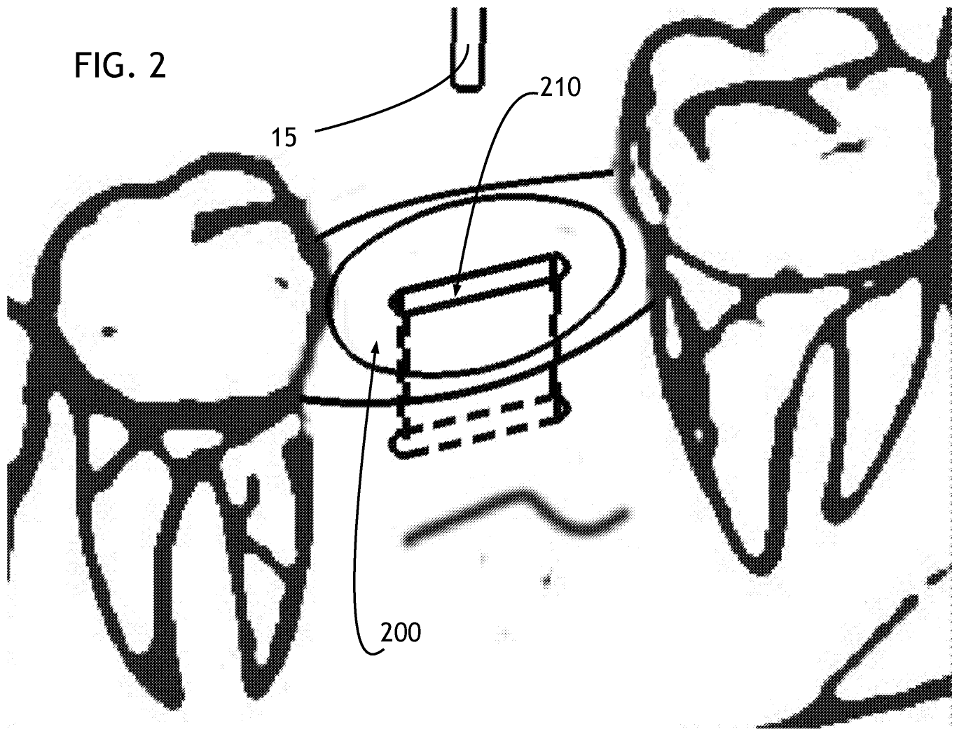

In reference to FIGS. 1 and 2, an area 200 is surgically prepared for receiving an implant. High speed handpiece 10 and attached cylindrical cutting bur 15 are utilized by the dental professional to create implant retention slot 210 that is centrally located within structural bone 20 in a prepared area 220. The cutting of slot 210 is customizable for each patient as angle, depth and size are variable and are designed to be pre-planned prior to surgery. Implant retention slot 210 is designed to frictionally retain the implant prosthetic during the healing and osseointegration process. When the treatment is complete, both slot 210 and prepared area 220 will become fully osseointegrated as an integral whole.

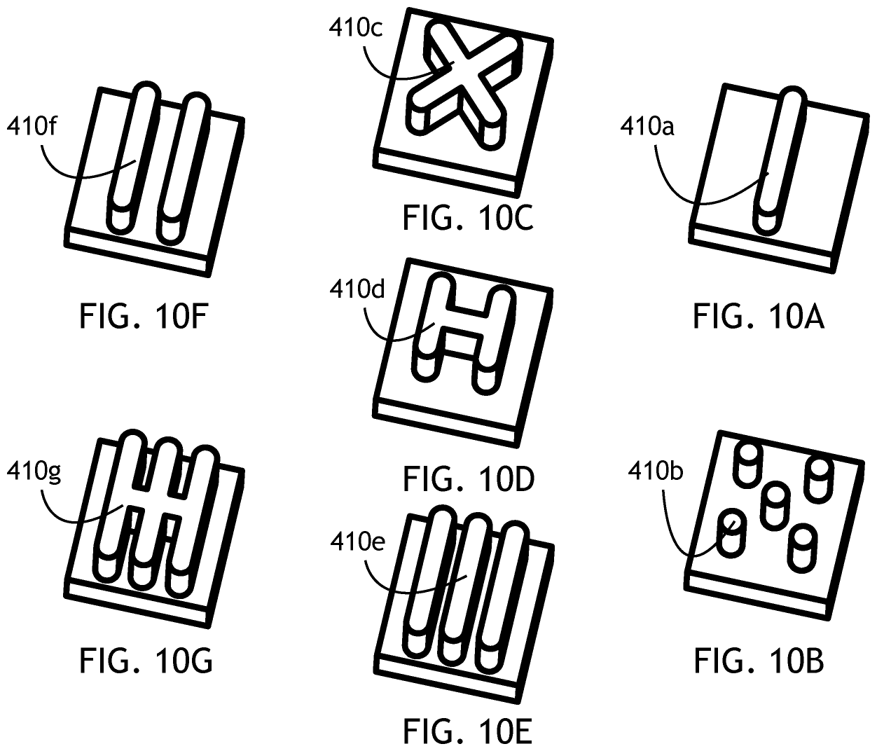

An embodiment of the present invention utilizes cutting bur 15 to create the various sizes, shapes, tapers, depths and especially widths that can be tailored for each patient. FIGS. 10A-10G show examples of various prosthetic implant fin designs (410a-410g) that can be manufactured by cutting different slot patterns in jawbone 20. The various slot patterns provide the professional with options to increase the retention of the prosthetic while it is osseointegrating. The best pattern will likely be chosen after the professional ascertains how much volume of bone is available with which to work. The practitioner may then remove additional soft tissue, with a scalpel, laser, or other implement, that is of a size and shape that corresponds to the external lateral dimensions of the final implant prosthetic, finishing the osseointegrable prosthetic implant area 220 which is designed to lie directly underneath the prosthetic that resembles a tooth. Any bleeding initiated by cutting slot 210 and area 220 may be arrested by means of haemostatic agents such as ferric sulfate, ferric chloride, aluminum chloride, aluminum sulfate, epinephrine and/or any haemostatic agent capable of slowing, constricting, clotting or staunching the flow of blood.

A three-dimensional model of the treatment area must be made to form the custom implant. One manner to do this is to create a physical impression, a technique long practiced in the art. An impression of the treatment area may be taken, where FIG. 3 shows a material impression 300 taken of the treatment area of FIG. 1. As can be seen, the impression details of both slot 210 and area 220 are acquired. Material impression 300 may be generated by any materials and means known in the art or later discovered. Currently, impressions are generally created from a two-part mixed flowable material that hardens into a flexible elastomer over the course of a few minutes; usually a poly siloxane, poly ether, or other impression material. The two-part impression materials are mixed and appropriately placed in/over slot 210 and area 220 while it is in a flowable state and then removed when it becomes fully hardened, thus forming material impression 300. Material impression 300 is designed to retain an accurate rendering of the treatment area 200 of FIG. 1, which preserves the impression topography and details of implant retention slot 310 and exposed bone area 320, which are negatives of implant retention slot 210 and the exposed treatment area 220.

Material impression 300 is then scanned by means of an intra-oral camera, scanner or other device such that via the collection of multiple images an accurate rendering of the impression is digitally recorded and through the utilization of CAD-CAM software a digital three-dimensional image is produced. The software then assists the practitioner in creating a three-dimensional digital model that is designed to fit into implant retention slot 210, exposed bone area 220, and also may digitally construct the remaining portions of the restoration that resembles a tooth.

As an alternative, the slot and treatment area may be directly digitally scanned if appropriate technology is possessed by the practitioner. This method forgoes the intermediate impression step and directly creates the digital model from the patient's mouth.

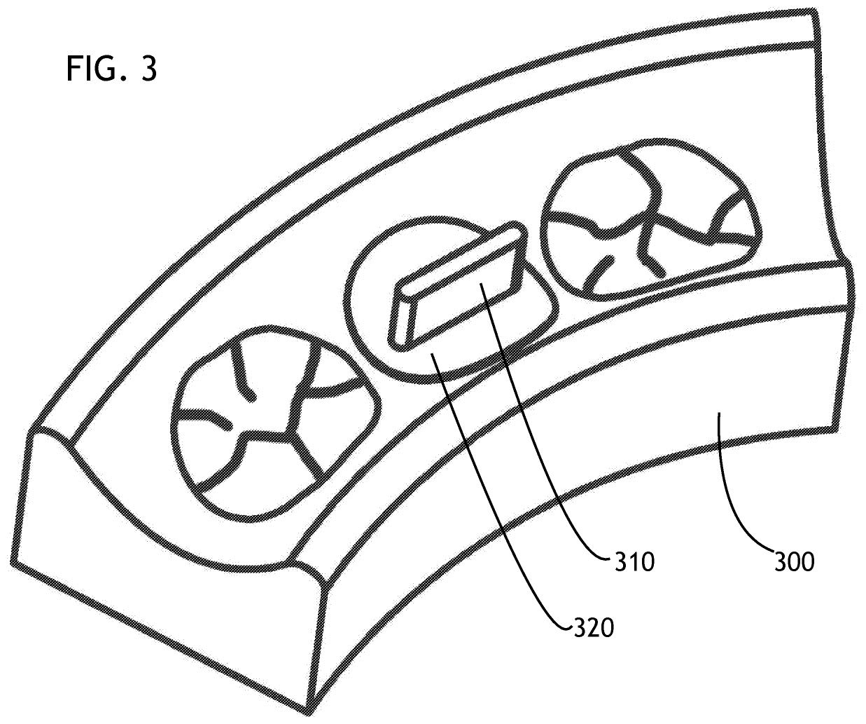

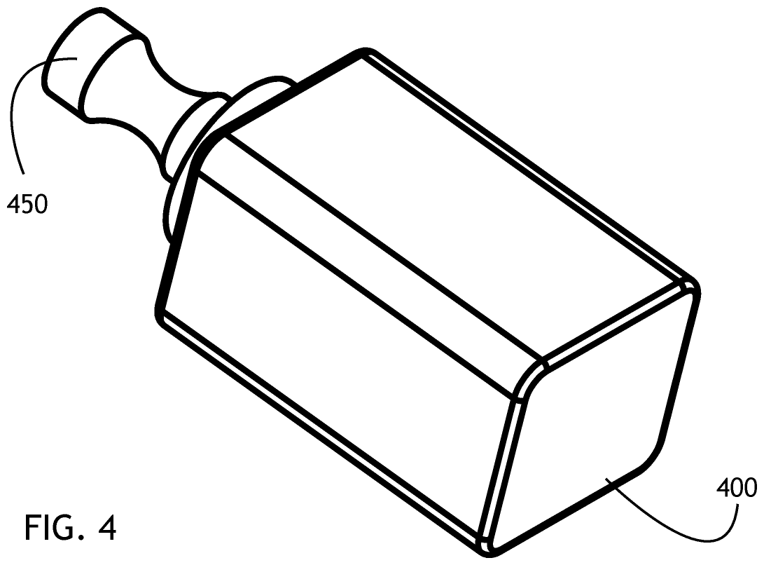

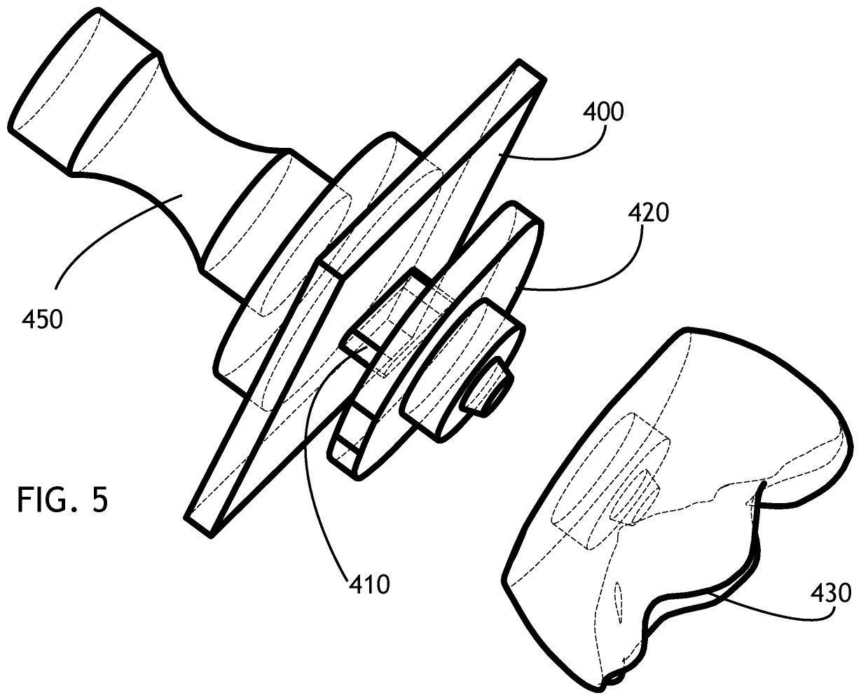

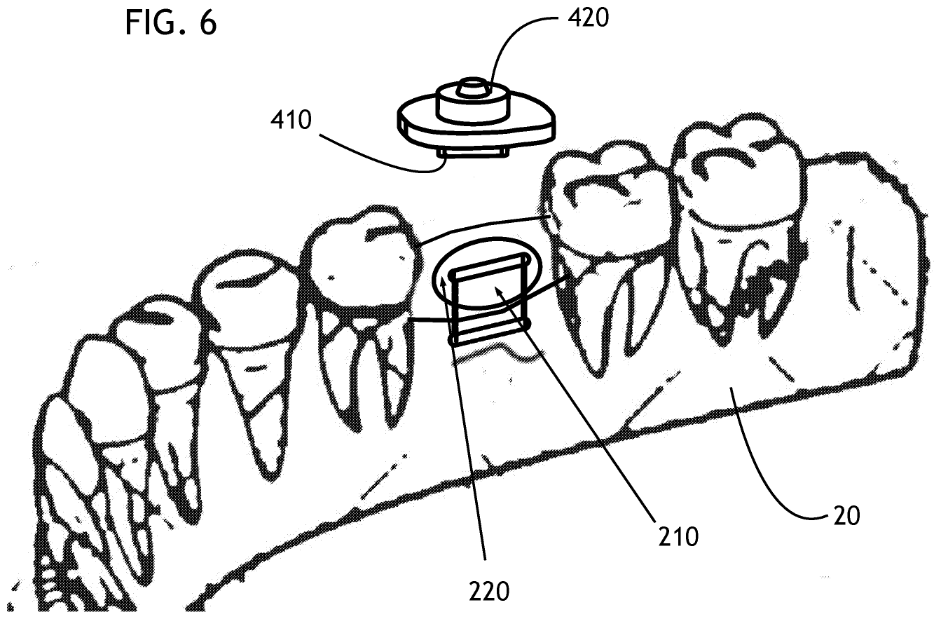

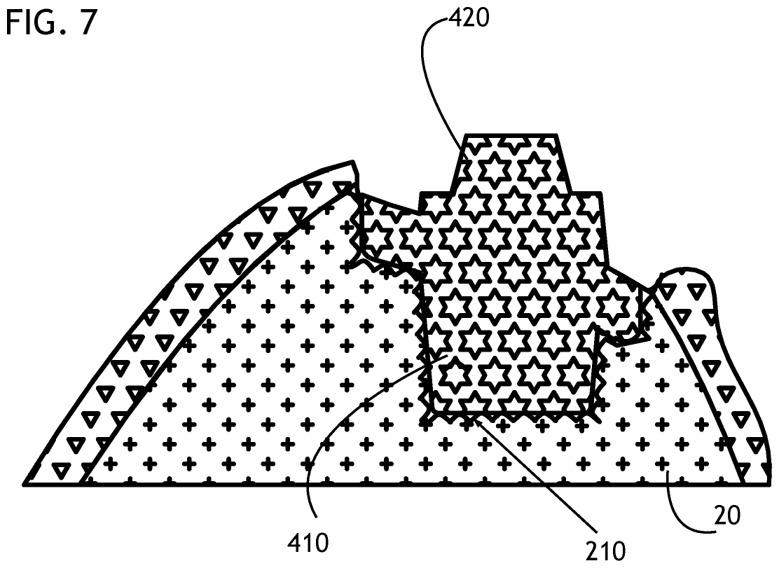

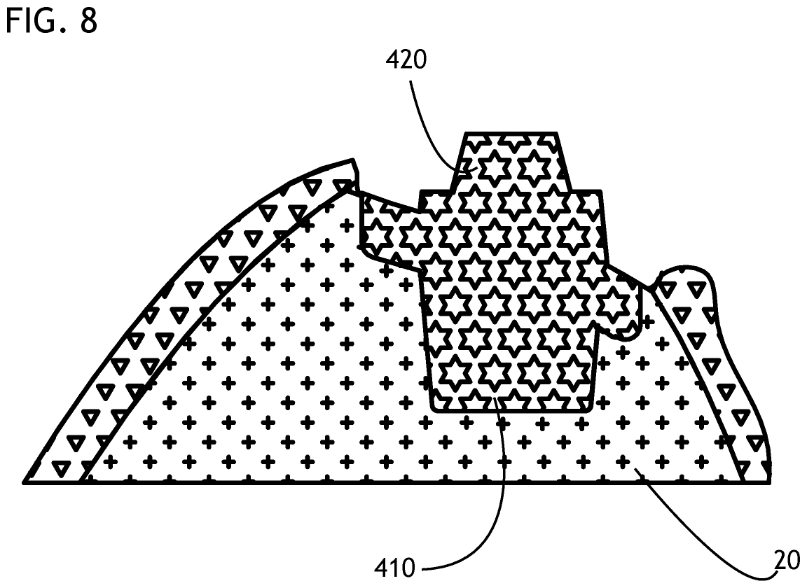

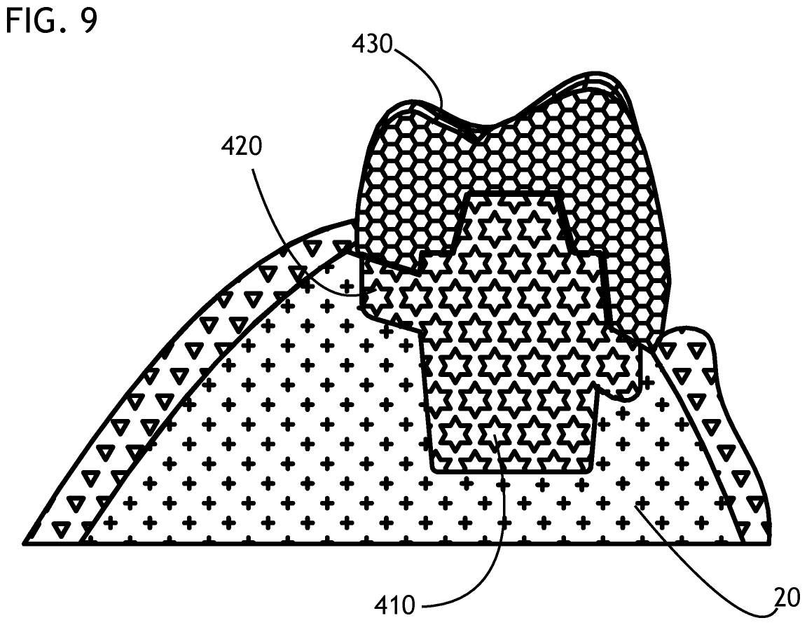

Once the three-dimensional digital modeling is complete, the image file of the model is uploaded to a CNC milling machine whereupon block holder 450 is installed into the operational chuck of said CNC milling machine. FIG. 4 depicts an embodiment of the present invention showing osseointegrable block 400 attached onto block holder 450. The CNC milling machine is then activated and with respect to the digital image file, the block 400 of osseointegrable material is cut, in a manner like that shown in FIG. 5. A retention implant post 420 and custom tooth crown restoration 430 are reproduced as the osseointegrable portion and cemented restorative portion of the implant prosthetic. It should be noted that the crown 430 may also be, instead, a temporary crown. Implant post 420 is designed with a fin 410 to be installed first into slot 210 until it is fully healed and osseointegrated, then the restoration is completed by permanently cementing in place the custom tooth crown restoration 430. While the crown restoration 430 is shown in FIG. 5 having been fashioned from the same osseointegrable block 400 as the implant post 420, it will not osseointegrate. Therefore, the crown may be fashioned from any number of other acceptable materials currently known or later discovered in the art. Nothing in the Specification should be read to require the crown restoration 430 and the implant post 420 to be made of the same material, though it may be convenient to fashion them during the same CNC session. Also note in FIGS. 6 and 7, the implant 420 alone is being installed in slot 210. Fin 410 imperfectly fits in slot 210 and the remaining portion of the implant 420 covers the prepared osseointegrable area 220. This strategy allows to the jaw 20 to heal and osseointegrate with the implant 420, both its main body and the fin 410 (FIG. 8), before placing the crown restoration 430. This prevents the implant 420 from being placed under the forces of occlusion because these repetitive forces are likely to interrupt the healing process. Thereafter, it is preferred to position the restorative portion 430 and cement it into place, which then does allow occlusion to occur (FIG. 9).

It is to be understood that the dimensions of retention post 420 and restorative portion 430 can be modified by way of the CAD CAM software; such that the fit can be altered to achieve a desired result. An example of an embodiment of this type of alteration is demonstrated by slightly enlarging retention implant post fin 410; such that when retention post 420 is inserted in retention slot 210 the fit is tight and the retention of the finished prosthetic is maximized during the healing process. As discussed before, many fin designs are possible, as shown in FIGS. 10A-10G and may be utilized at the discretion of the practitioner. Each different design may impart a different hold of the implant 420 in the retention slot 210 and may promote healing and osseointegration. The practitioner would ideally decide based upon preference, available space and bone mass, and any other relevant consideration.

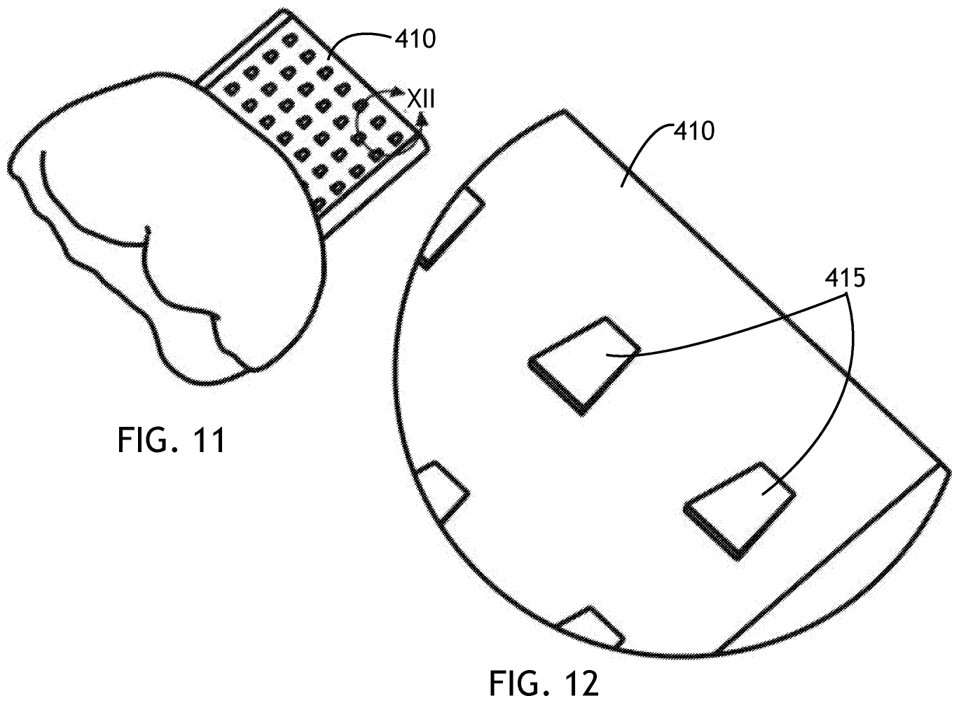

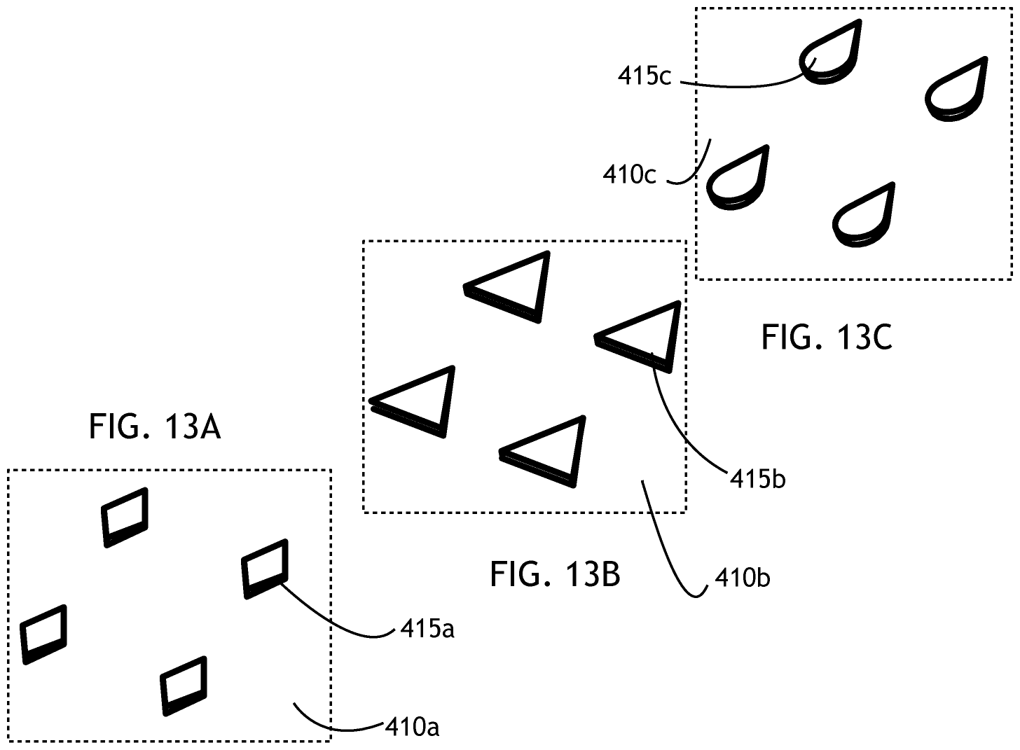

Another embodiment of the present invention, shown in FIG. 11, engraves protrusion friction marks 415 onto osseointegrable fin 415. Protrusion marks 415 are engraved by means of micro-milling, laser engraving or any other method capable of engraving fine detail. FIG. 12 is a close-up view of an embodiment of the present invention demonstrating an example of protrusion mark 415. Protrusion marks 415 are designed to minimize the force required to insert implant post 420 into retention slot 210; and at the same time maximize the retention by way of friction from any force that would attempt to pull the finished prosthetic from retention slot 210. It is preferred that protrusion marks 415 have a sloped configuration and are designed to minimize the force required to insert the finished implant prosthetic into retention slot 210. The downward slant of the slope should be in the direction of retention slot 210. Once installed, the prominent areas of protrusion marks 415 are forced against the bone of retention slot 210 and are designed to slowly embed themselves into the natural sponginess of natural bone to maximize retention. Other exemplary shapes of protrusion marks 415a, 415b, 415c, are shown in FIG. 13. The sloped friction marks have various shapes by design, such as rectangular, diamond, square, teardrop, triangular and any other shape that is designed to minimize the force required to insert the finished implant prosthetic into retention slot 210, and at the same time maximize the retention by way of friction from any force that would attempt to pull the finished prosthetic from retention slot 210.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A method of providing a custom osseointegrated implant, the method of comprising:
preparing an osseointegrable implant area by:
cutting a slot into underlying bone tissue;
clearing soft tissue from over the underlying bone tissue, maximizing the osseointegrable area; and
creating a model of the osseointegrable area and the slot;
creating an osseointegrable implant based upon the model;
installing the osseointegrable implant into the slot and onto the osseointegrable area; and, allowing the osseointegrable area and the slot to heal and osseointegration with the implant to occur.

2. The method of claim 1, the step of creating a model of the osseointegrable area and the slot being accomplished by:
first creating a physical impression of the osseointegrable area and the slot;
scanning the impression to create a three-dimensional image file of said impression; and,
modifying said image file to create the model.

3. The method of claim 2, the step of creating the osseointegrable implant being accomplished by milling a block of osseointegrable material into a form based upon the model.

4. The method of claim 3, wherein a crown is also milled from the same block of osseointegrable material as the implant.

5. The method of claim 3, the block of osseointegrable material containing at least one osseointegrable material selected from the set of osseointegrable materials consisting of: bone, teeth, artificial bone, artificial teeth, coral, seashells, calcium phosphates, calcium carbonate, calcium phosphate tribasic, calcium phosphate dibasic, calcium phosphate monobasic, porcelains, ceramics, cements, and metals.

6. The method of claim 1, the step of creating a model of the osseointegrable area and the slot being accomplished by:
first creating a digital impression of the osseointegrable area and the slot; and, modifying said image file to create the model.

7. The method of claim 2, the step of creating the osseointegrable implant being accomplished by milling a block of osseointegrable material into a form based upon the model.

8. The method of claim 3, wherein a crown is also milled from the same block of osseointegrable material as the implant.

9. The method of claim 3, the block of osseointegrable material containing at least one osseointegrable material selected from the set of osseointegrable materials consisting of: bone, teeth, artificial bone, artificial teeth, coral, seashells, calcium phosphates, calcium carbonate, calcium phosphate tribasic, calcium phosphate dibasic, calcium phosphate monobasic, porcelains, ceramics, cements, and metals.
